(19) United States
(12) Patent Application Publication
(10) Pub. No.: US 2026/0339718 A1
(43) Pub. Date: Oct. 29, 2026

(54) SYSTEMS AND METHODS FOR HARDWARE OFFLOAD OF ISCSI AND NVME/TCP PROTOCOLS

(71) Applicant: SpeedNIC LLC, Austin, TX (US)

(72) Inventors: Venkata Suman Kumar M, Bengaluru (IN); Varun Prakash, Bengaluru (IN)

(21) Appl. No.: 19/187,702

(22) Filed: Apr. 23, 2025

(51) Int. Cl. G06F 9/50; H04L 69/16; H04L 69/22

(52) U.S. Cl. CPC G06F 9/5027; H04L 69/161; H04L 69/22; G06F 2209/509

(57) ABSTRACT

A computing device may include a hardware offload driver, and a network adapter communicatively coupled to the hardware offload driver. The network adapter may include iSCSI and NVMe/TCP transmit and receive offload module, Direct Data Placement (DDP) module, TCP/IP module. The computing device may offload multiple computing resource intensive tasks for iSCSI and NVMe/TCP protocols to the network adapter. Computing resource intensive tasks include TCP/IP processing, header and data digest insertion and validation, copying of data from network driver buffers to iSCSI and NVMe/TCP stack buffers. These tasks consume multiple CPU cycles, memory bandwidth and increase I/O latency. Offloading these tasks to the network adapter may result in significant reduction in computing device CPU cycles, memory bandwidth utilization and I/O latency.

### TECHNICAL FIELD

The present disclosure relates generally to computing devices and processes. Specifically, the present disclosure relates to systems and methods for hardware offload of computing resource intensive tasks for iSCSI and NVMe/TCP protocols to a network adapter.

### BACKGROUND

Computing networks are ubiquitously utilized to transfer data between computing devices within those networks. Computing devices within the networks may constantly send and receive large amounts of data between the computing devices. A number of protocols may be utilized to facilitate in the preparation, transmission, and receipt of data between computing devices within the networks. Internet small computer systems interface (iSCSI), and non-volatile memory (NVM) Express (NVMe)/transmission control protocol (TCP) (NVMe/TCP) may be included in these protocols.

During data transmit (TX) and receive (RX) processes iSCSI and NVMe/TCP-based applications may perform multiple computing resource intensive tasks. These computing resource intensive tasks may include, for example, TCP/IP processing, header and data digest computations, copying of data from network driver buffers to iSCSI or NVMe/TCP stack buffers, and other tasks. These operations consume multiple CPU cycles and memory bandwidth to complete and may be a significant drain on computing resources.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a block diagram of an operating system (OS) and a network adapter within a computing device, according to an example of the principles described herein.

FIG. 2 illustrates a block diagram of data transmit (TX) and data receive (RX) processes using hardware offloading within the OS and a network adapter of FIG. 1, according to an example of the principles described herein.

FIG. 3 illustrates a component diagram of example components of a computing device including the OS and network adapter of FIGS. 1 and 2, according to an example of the principles described herein.

FIGS. 4A-4E illustrate diagrams of data packets including a header, a data digest, and TCP, IP, and Ethernet headers, according to an example of the principles described herein.

FIG. 5 illustrates a packet transfer diagram including an input/output (I/O) request and data packet that are transmitted with the DDP TAG, according to an example of the principles described herein.

FIG. 6 illustrates multiple hardware offload features according to an example of the principles described herein.

FIG. 7 illustrates a flow diagram of an example method for hardware offload utilizing PDU transmit work request (WR) processing by a network adapter, according to an example of the principles described herein.

FIG. 8 illustrates a flow diagram of an example method for hardware offload utilizing Ethernet frame receive (RX) processing by a network adapter, according to an example of the principles described herein.

FIG. 9 illustrates a flow diagram of an example method of DDP, according to an example of the principles described herein.

FIG. 10 illustrates a flow diagram of an example method of DDP, according to an example of the principles described herein.

FIG. 11 illustrates a flow diagram of an example method of DDP, according to an example of the principles described herein.

FIG. 12 illustrates a block diagram illustrating certain components of an example node that may be utilized to implement various aspects of the technologies disclosed herein.

FIG. 13 illustrates a computing system diagram illustrating a configuration for a data center that can be utilized to implement aspects of the technologies disclosed herein.

### DESCRIPTION OF EXAMPLE EMBODIMENTS

As noted above, during data TX and RX processes iSCSI and NVMe/TCP-based applications may perform multiple computing resource intensive tasks that consume multiple CPU cycles and memory bandwidth to complete and may be a significant drain on computing resources. Thus, if processing is performed via software by a host device such as the CPU, this may require significant amounts of computing resources including, for example, processing cycles and memory bandwidth. Therefore, it is advantageous to remove the processing and memory overhead of the host computing device to other resources within the host computing device. The present systems and methods remove this processing overhead from the CPU and associated operating system (OS) to a network adapter and associated processing and memory resources. Migration of these processes to the network adapter allows for the host computing device to focus on other processing tasks. Further, in one example, a portion of the processing load may be pushed to the hardware of the network adapter, and a portion of the processing load may remain with and be processed by the CPU. By offloading these processing tasks to the network adapter, the computing device may experience a significant reduction in CPU and memory bandwidth utilization and input/output (I/O) latency.

This disclosure describes transmit (TX) and receive (RX) offloading processes for transmission and reception of data between two computing devices within a network. To transmit data, an application associated with the network adapter may provide a PDU transmit work request which includes header buffer and data buffer direct memory buffer (DMA) addresses, lengths and maximum PDU size to the network adapter. The network adapter may form multiple iSCSI or NVMe/TCP protocol data units (PDUs) based on a maximum PDU size, may add pad bytes, may add header and data digest, and may transmit PDUs via TCP/IP stack in the network adapter, and may send PDU transmit completion message to the hardware offload driver. On receiving TCP segments, the network adapter does TCP/IP processing, delineate iSCSI or NVMe/TCP PDUs within TCP payload, validate the header and data digest, remove pad bytes, and directly place the solicited PDU data into the pre-posted iSCSI or NVMe/TCP stack buffers and immediate, unsolicited PDU data and PDU header into the pre-posted hardware offload driver buffers and may send PDU receive completion message to the hardware offload driver. The iSCSI, NVMe/TCP stack buffers and hardware offload driver memory buffers may include computing device, network adapter and storage device (e.g. NVMe SSD) memory buffers.

Examples described herein provide a computing device may include a hardware offload driver, and a network adapter communicatively coupled to the hardware offload driver. The network adapter may include a iSCSI and NVMe/TCP transmit and receive offload module, Direct Data Placement (DDP) module, TCP/IP module which performs operations including, during a transmit offload process, receiving from the hardware offload driver, PDU transmit work request including PDU header and data buffer DMA addresses, lengths and maximum PDU size for offloading PDU transmit operation to the network adapter, and generating a plurality of iSCSI or NVMe/TCP protocol data units (PDUs) from the header and data buffers based at least in part on a maximum PDU size. Further, during a receive offload process, the operations may include, TCP/IP processing, delineating iSCSI or NVMe/TCP PDUs within TCP payload.

The computing device may further include an internet small computer systems interface (iSCSI) stack, and a non-volatile memory (NVM) Express (NVMe)/transmission communication protocol (NVMe/TCP) stack. The iSCSI stack and the NVMe/TCP stack may be communicatively coupled to the hardware offload driver.

The PDU transmit work request for offloading PDU transmit operation to the network adapter may include header buffer and data buffer DMA addresses, lengths and maximum PDU size. The generating of the plurality of iSCSI or NVMe/TCP PDUs from the PDU transmit work request may be based at least in part on a maximum PDU size.

The transmit offload process may further include adding pad bytes, adding a header and a data digest to the PDUs and transmitting PDUs via TCP/IP stack in the network adapter and sending PDU transmit completion message to the hardware offload driver.

The receive offload process may further include, based at least in part on receiving a complete iSCSI or NVMe/TCP PDU, validating the header and the data digest within the PDU, removing pad bytes, placing solicited PDU data into the pre-posted iSCSI or NVMe/TCP stack buffers and immediate, unsolicited PDU data and PDU header into the pre-posted hardware offload driver buffers and sending PDU receive completion message to the hardware offload driver. The iSCSI, NVMe/TCP stack buffers and hardware offload driver buffers may include computing device, network adapter and storage device (e.g. NVMe SSD) memory buffers.

Examples described herein also provide a non-transitory computer-readable medium storing instructions that, when executed, causes a processor to perform operations, including, during a transmit offload process at a network adapter, receiving from a hardware offload driver of an operating system, PDU transmit work request for offloading PDU transmit operation to the network adapter, and generating a plurality of iSCSI or NVMe/TCP protocol data units (PDUs) from the PDU transmit work request based at least in part on a maximum PDU size. Further, the operations may include, during a receive offload process at the network adapter, TCP/IP processing, delineating iSCSI or NVMe/TCP PDUs within TCP payload.

The PDU transmit work request for offloading PDU transmit operation to the network adapter may include header buffer and data buffer DMA addresses, lengths and maximum PDU size. The generating of the plurality of PDUs from the PDU transmit work request may be based at least in part on a maximum PDU size.

The transmit offload process may further include adding pad bytes, adding a header and a data digest to the PDUs and transmitting PDUs via TCP/IP stack in the network adapter and sending PDU transmit completion message to the hardware offload driver.

The receive offload process may further include, based at least in part on receiving a complete iSCSI or NVMe/TCP PDU, validating the header and the data digest within the PDU, removing pad bytes and directly placing the solicited PDU data into the pre-posted iSCSI or NVMe/TCP stack buffers and immediate, unsolicited PDU data and PDU header into the pre-posted hardware offload driver buffers and sending PDU receive completion to the hardware offload driver. The iSCSI, NVMe/TCP stack buffers and hardware offload driver buffers may include computing device, network adapter and storage device (e.g. NVMe SSD) memory buffers.

Examples described herein also provide a method for hardware offload, including, with iSCSI and NVMe/TCP transmit and receive offload module, Direct Data Placement (DDP) module, TCP/IP module of a network adapter, performing a transmit offload process including receiving from a hardware offload driver of an operating system, PDU transmit work request for offloading PDU transmit operation to the network adapter, and generating a plurality of iSCSI or NVMe/TCP protocol data units (PDUs) from the PDU transmit work request based at least in part on a maximum PDU size. The method may further include performing a receive offload process comprising TCP/IP processing, delineating iSCSI or NVMe/TCP PDUs within TCP payload.

The transmit offload process may further include adding pad bytes, adding a header and a data digest to the PDUs and transmitting PDUs via TCP/IP stack in the network adapter and sending a PDU transmit completion message to the hardware offload driver.

The receive offload process may further include, based at least in part on receiving a complete iSCSI or NVMe/TCP PDU, validating the header and the data digest within the PDU, removing pad bytes, placing the solicited PDU data into the pre-posted iSCSI or NVMe/TCP stack buffers and immediate, unsolicited PDU data and PDU header into the pre-posted hardware offload driver buffers and sending PDU receive completion message to the hardware offload driver. The iSCSI, NVMe/TCP stack buffers and hardware offload driver buffers may include computing device, network adapter and storage device (e.g. NVMe SSD) memory buffers.

For Direct Data Placement (DDP) hardware offload driver at a data-receiving computing device may allocate a DDP TAG. This DDP TAG defines a region within a memory. Hardware offload driver may write data buffer DMA addresses and lengths in the memory region defined by the DDP TAG and may fill the DDP TAG and data transfer length in Read command PDU header, or fill DDP TAG, buffer offset and data transfer length in the R2T PDU header and send Read command or R2T PDU to data-transmitting computing device via PDU transmit work request.

A data-transmitting computing device on receiving a Read command or R2T PDU may fill the DDP TAG, buffer offset and data length in the header of a data PDU and send data PDU(s) to the data-receiving computing device.

The network adapter at the data-receiving computing device receives the data PDU. The DDP module of the network adapter may utilize the DDP TAG in the data PDU header as an index to fetch data buffer DMA addresses and lengths from the memory and DMA writes the data into the data buffers.

Additionally, the techniques described in this disclosure may be performed as a method by the hardware of the network adapter and/or by a system having non-transitory computer-readable media storing computer-executable instructions that, when executed by one or more processors, performs the techniques described above.

### EXAMPLE EMBODIMENTS

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

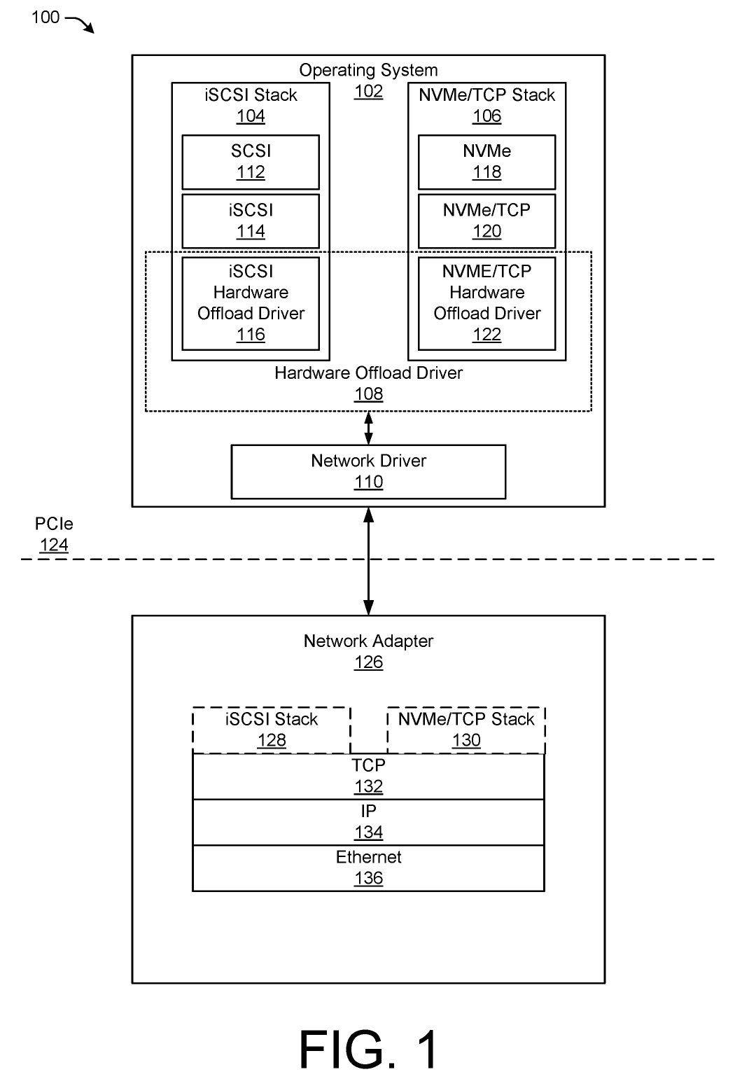

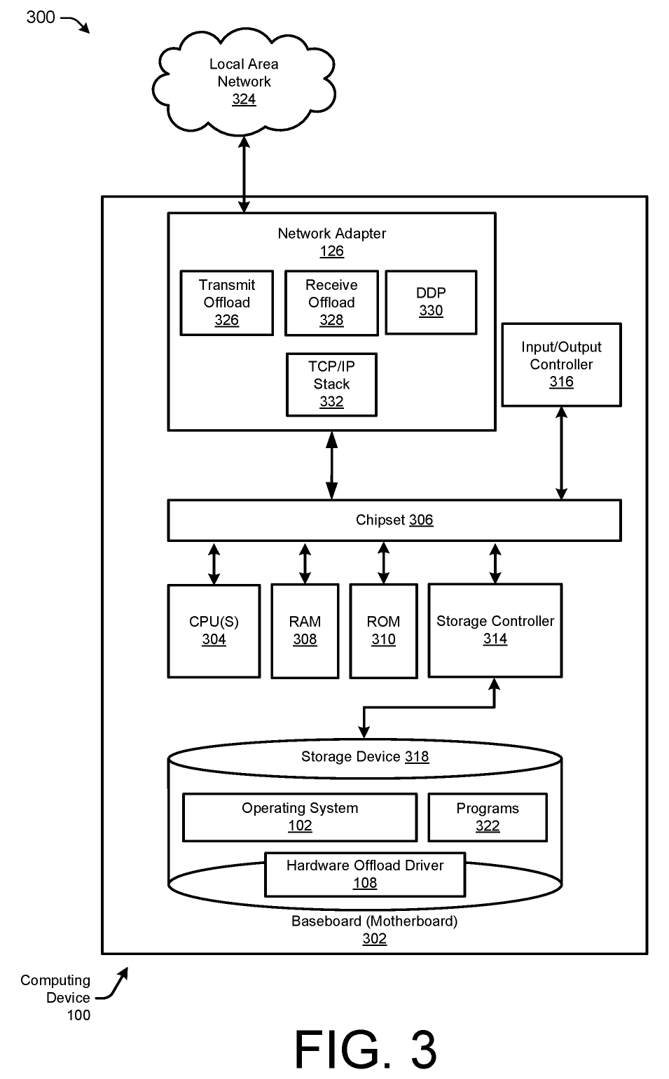

FIG. 1 illustrates a block diagram of an operating system (OS) 102 and a network adapter 126 within a computing device 100, according to an example of the principles described herein. More details regarding the computing device 100 are provided herein in connection with FIG. 3. However, in order to more fully describe the hardware offload processes described herein, the OS 102 as depicted in FIG. 1 may include a plurality of protocol stacks including any implementations of a computer networking protocol suite or protocol family such as communication protocols with the stack being the software implementation of them. As individual protocols within the suite may be designed with a single purpose in mind, the OS 102 may include those protocols and associated protocol stacks that bring about the methods, purposes, and advantages of the hardware offload implementations described herein. For example, as depicted in FIG. 1, the OS 102 may include a first Internet small computer systems interface (iSCSI) stack 104 and a first non-volatile memory (NVM) Express (NVMe)/transmission control protocol (TCP) (NVMe/TCP) stack 106. The first iSCSI stack 104 may include an SCSI protocol layer 112, an iSCSI protocol layer 114, and an iSCSI hardware offload driver 116. Similarly, the first NVMe/TCP stack 106 may include an NVMe protocol layer 118, an NVMe/TCP protocol layer 120, and an NVMe/TCP hardware offload driver 122.

The iSCSI hardware offload driver 116 and the NVMe/TCP hardware offload driver 122 may serve as the hardware offload driver 108 included within the OS 102. The OS 102 may, via the hardware offload driver 108, move processing to the network adapter 126 as described herein. Therefore, in one example, the OS 102 may not include additional protocols located at other layers such as, for example, a TCP transport layer (e.g., layer 4) protocol, an Internet protocol (IP) network layer (e.g., layer 3) protocol, and an Ethernet data link layer (e.g., layer 3) protocol. The processing associated with these layers may be moved to the network adapter 126 via the hardware offload driver 108 including the iSCSI hardware offload driver 116 and the NVMe/TCP hardware offload driver 122.

A peripheral component interconnect express (PCI Express or PCIe) interface 124 may couple the OS 102 and the network adapter 126. The PCIe interface 124 may include any high-speed serial computer expansion bus interface but may be any type of interface.

The network adapter 126 may include any network interface controller (NIC), network interface card, local area network (LAN) adapter, physical network interface, or similar computer hardware component that connects a computing device (e.g., computing device 100) to a computer network and other computing devices coupled to the network. As depicted in FIG. 1, the network adapter 126 may include a corresponding second iSCSI stack 128 and second NVMe/TCP stack 130 that serves as the resources that are able to receive the processing requirements offloaded by the hardware offload driver 108. The second iSCSI stack 128 and second NVMe/TCP stack 130 may be associated with the TCP transport layer (e.g., layer 4) protocol 132, the Internet protocol (IP) network layer (e.g., layer 3) protocol 134, and the Ethernet data link layer (e.g., layer 3) protocol 136. In this manner, a significant amount or bulk of the processing may be pushed off of the OS 102 and the CPU associated therewith, and, instead, onto the network adapter 126 and the resources of the network adapter 126.

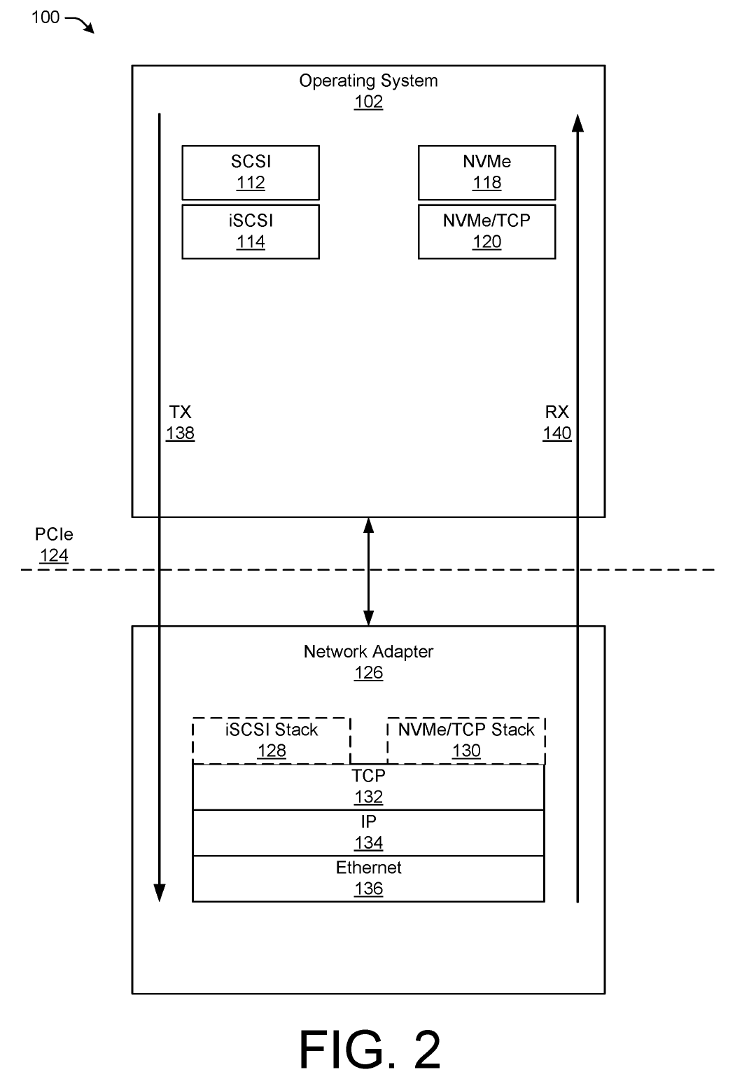

FIG. 2 illustrates a block diagram of data transmit (TX) 138 and data receive (RX) 140 processes using hardware offloading within the OS 102 and a network adapter 126 of FIG. 1, according to an example of the principles described herein. The data TX 138 and data RX 140 may be processed differently as data is sent by and received at the computing device 100. As to the data TX 138 process, the network adapter 126 of the computing device 100 may receive a PDU transmit work request (WR) from the hardware offload driver 108 and/or the network driver 110 of the OS 102. The hardware offload driver 108 and/or the network driver 110 act as a bridge between hardware and software within the computing device 100 and define messages and mechanisms through which the OS 102 and/or applications executed by the OS 102 may access the computing device 100 including the network adapter 126. The hardware offload driver 108 and/or the network driver 110 may make requests for the network adapter 126 to transmit data to another computing device to which the computing device 100 is coupled via the network. Thus, an application executing on the computing device 100 may cause data to be transmitted from the computing device 100 to another computing device and may utilize the transmit WR sent to the network adapter 126 for processing that data transmission. In doing so, the application and/or the OS 102 may execute the hardware offload driver 108 and/or the network driver 110 to send any data and information the network adapter 126 may require for transmitting PDUs. The network adapter 126 may include any processing and memory resources required to perform the processing and tasks described herein.

Once the transmit WR is received from the OS 102, the network adapter 126 may utilize direct memory access (DMA) to read the iSCSI or NVMe/TCP headers and iSCSI or NVMe/TCP data buffers into memory buffers (not shown) of the network adapter 126. The network adapter 126 may form multiple iSCSI or NVMe/TCP based protocol data units (PDUs) based on a PDU size specified in the transmit WR. For example, the transmit WR may include a maximum PDU size, but the size of the data that is to be sent via the transmit WR may be larger than the maximum PDU size. Therefore, the network adapter 126 may create multiple PDUs such that each PDU has less than or equal to a maximum amount of data based on the maximum PDU size.

Further, the network adapter 126 may add pad bytes, and may compute and add header and data digest information for each of the PDUs. Although described herein as including the pad bytes and header and data digest information for each of the PDUs, the pad bytes and header and data digest information may be optional. Further, the network adapter 126 may transmit the PDUs via TCP/IP stack in the network adapter to another computing device within the network and the network adapter may send PDU transmit completion message to the hardware offload driver. In this manner, the OS 102 may offload a large portion of the data processing tasks associated with the transmit WR including the packaging and transmission of the data to the network adapter 126.

As to the data RX 140 process, the network adapter 126 may receive an Ethernet frame with TCP segment comprising complete or partial iSCSI or NVMe/TCP PDU(s) from a computing device connected to the network adapter 126 via the network. The network adapter 126 may perform TCP/IP processing. The network adapter 126 may also delineate iSCSI or NVMe/TCP PDU(s) within TCP payload.

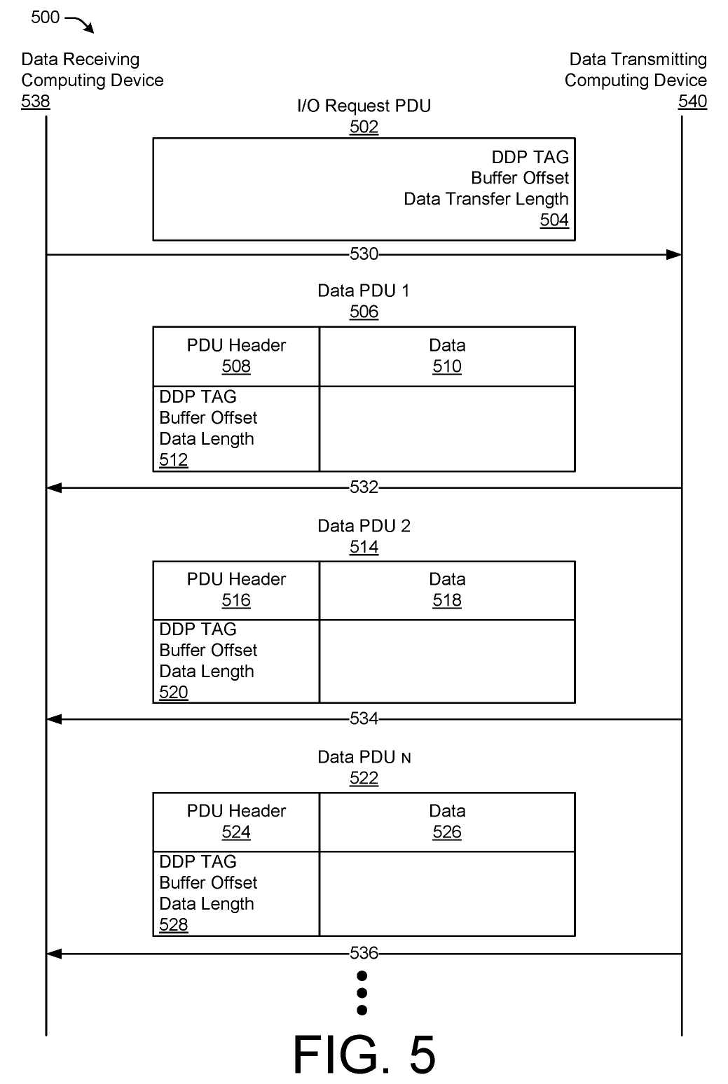

Optionally, the network adapter 126 may compute and validate header and data digest information for each of the PDU(s) and remove pad bytes. The network adapter 126 may then utilize DMA to write the solicited PDU data into pre-posted iSCSI or NVMe/TCP stack buffers and immediate, unsolicited PDU data into the pre-posted hardware offload driver buffers. The network adapter 126 may then utilize DMA to also write iSCSI or NVMe/TCP headers into the pre-posted hardware offload driver buffers and then send PDU receive completion to the hardware offload driver. The iSCSI, NVMe/TCP stack buffers and hardware offload driver buffers may include computing device, network adapter and storage device (e.g. NVMe SSD) memory buffers. More regarding the data TX 138 and data RX 140 processes will be describe below in connection with FIGS. 5 through 7.

FIG. 3 illustrates a component diagram of example components of a computing device including the OS 102 and network adapter 126 of FIGS. 1 and 2, according to an example of the principles described herein. FIG. 3 depicts an example computer architecture for the computing device 300 capable of executing program components for implementing the functionality described herein. The computer architecture shown in FIG. 3 illustrates a server computer, workstation, desktop computer, laptop, tablet, network appliance, e-reader, smartphone, or other computing device, and may be utilized to execute any of the software and/or hardware components presented herein. The computing device 300 may, in one example, correspond to a physical server of a data center, a packet switching system, and/or a node within a computing network as described herein.

The computing device 300 may include a baseboard 302, or “motherboard,” which may include a printed circuit board to which a multitude of components or devices may be connected by way of a system bus or other electrical communication paths. In one illustrative configuration, one or more central processing units (“CPUs”) 304 may operate in conjunction with a chipset 306. The CPUs 304 may be programmable processors that perform arithmetic and logical operations necessary for the operation of the computing device 300.

The CPUs 304 perform operations by transitioning from one discrete, physical state to the next through the manipulation of switching elements that differentiate between and change these states. Switching elements may include, for example, electronic circuits that maintain one of two binary states, such as flip-flops, and electronic circuits that provide an output state based on the logical combination of the states of one or more other switching elements, such as logic gates. These switching elements may be combined to create more complex logic circuits, including registers, adders-subtractors, arithmetic logic units, floating-point units, and other logic circuits.

The chipset 306 provides an interface between the CPUs 304 and the remainder of the components and devices on the baseboard 302. The chipset 306 may provide an interface to a RAM 308, used as the main memory in the computing device 300. The chipset 306 may further provide an interface to a computer-readable storage medium such as a read-only memory (“ROM”) 310 or non-volatile RAM (“NVRAM”) for storing basic routines that help to start up the computing device 300 and to transfer information between the various components and devices. The ROM 310 or NVRAM may also store other software components necessary for the operation of the computing device 300 in accordance with the configurations described herein.

The computing device 300 may operate in a networked environment using logical connections to remote computing devices and computer systems through a network, such as the local area network (LAN) 324. The chipset 306 may include functionality for providing network connectivity through the network adapter 126, such as a gigabit Ethernet adapter. The network adapter 126 may be capable of connecting the computing device 300 to other computing devices over the LAN 324. In one example, multiple network adapters 126 may be present in the computing device 300, connecting the computer to other types of networks and remote computer systems and performing in series the processes described herein.

The computing device 300 may be connected to a storage device 318 that provides non-volatile storage for the computing device 300. The storage device 318 may store an operating system 102, programs 322, the hardware offload driver 108, and data, which are described in greater detail herein. The storage device 318 may be connected to the computing device 300 through a storage controller 314 connected to the chipset 306. The storage device 318 may include one or more physical storage units. The storage controller 314 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 300 may store data on the storage device 318 by transforming the physical state of the physical storage units to reflect the information being stored. The specific transformation of physical state may depend on various factors, in different examples within this description. Examples of such factors may include, but are not limited to, the technology used to implement the physical storage units, whether the storage device 318 is characterized as primary or secondary storage, and other factors.

For example, the computing device 300 may store information to the storage device 318 by issuing instructions through the storage controller 314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 300 may further read information from the storage device 318 by detecting the physical states or characteristics of one or more particular locations within the physical storage units.

In addition to the mass storage device 318 described above, the computing device 300 may have access to other computer-readable storage media to store and retrieve information, such as program modules, data structures, or other data. The computer-readable storage media may include any available media that provides for the non-transitory storage of data and that may be accessed by the computing device 300. In one example, the operations performed by a computing resource network, and/or any components included therein, may be supported by one or more devices similar to computing device 300. Stated otherwise, some or all of the operations performed by a computing resource network and/or any components included therein, may be performed by one or more computing device 300 operating in a cloud-based arrangement.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned above, the storage device 318 may store an operating system 102 utilized to control the operation of the computing device 300. According to one example, the operating system comprises the LINUX operating system. According to another example, the operating system comprises the WINDOWS® SERVER operating system from MICROSOFT Corporation of Redmond, Washington. According to further examples, the operating system may comprise the UNIX operating system or one of its variants. It should be appreciated that other operating systems may also be utilized. The storage device 318 may store other system or application programs and data utilized by the computing device 300.

In one example, the storage device 318 or other computer-readable storage media may be encoded with computer-executable instructions which, when loaded into the computing device 300, transform the computer from a general-purpose computing system into a special-purpose computer capable of implementing the examples described herein. These computer-executable instructions transform the computing device 300 by specifying how the CPUs 304 transition between states, as described above. According to one example, the computing device 300 has access to computer-readable storage media storing computer-executable instructions which, when executed by the computing device 300, perform the various processes described herein. The computing device 300 may also include computer-readable storage media having instructions stored thereupon for performing any other computer-implemented operations described herein.

The computing device 300 may also include one or more input/output controllers 316 for receiving and processing input from a number of input devices, such as a keyboard, a mouse, a touchpad, a touch screen, an electronic stylus, or other type of input device. Similarly, an input/output controller 316 may provide output to a display, such as a computer monitor, a flat panel display, a digital projector, a printer, or other type of output device. It will be appreciated that the computing device 300 may not include all of the components shown in FIG. 3, may include other components that are not explicitly shown in FIG. 3, or might utilize an architecture completely different than that shown in FIG. 3.

The hardware offload driver 108 may be included within the storage device 318 or other data storage device such as the ROM 310 of the computing device 300 as depicted in FIG. 3. However, hardware offload driver 108 may be included within other devices within the computing device 300 such as, for example, the network adapter 126. The location of the hardware offload driver 108 may be dependent on the final destination where the data within a PDUs sent and received at the computing device 300 is to be stored either temporarily or semi-permanently.

Further, the network adapter 126 may include iSCSI and NVMe/TCP transmit module 326, iSCSI and NVMe/TCP receive offload module 328, Direct Data Placement (DDP) module 330 and TCP/IP module 332. The modules 326, 328, 330, and 332 may perform a number of processes in connection with the hardware offload of data TX 138 and data RX 140 processes described herein. For example, when executed by the network adapter 126 or other data processing device within the computing device 300, an iSCSI or NVMe/TCP large send offload (LSO) may be performed. Further, the network adapter may also add pad bytes and header and data digest into each PDU, may transmit PDU via TCP/IP stack in the network adapter and may send PDU transmit completion message to the hardware offload driver 108. Still further, on receiving a TCP segment the network adapter 126 may perform TCP/IP processing, delineate iSCSI or NVMe/TCP PDU within TCP payload, may validate header and data digest and remove pad bytes. The network adapter may also perform a direct data placement (DDP) of solicited PDU data utilizing direct memory access (DMA) into the pre-posted iSCSI or NVMe/TCP stack buffers and may directly place the immediate, unsolicited PDU data and PDU headers utilizing DMA into the pre-posted hardware offload driver buffers and send PDU receive completion to hardware offload driver 108. More regarding the processes performed by the network adapter 126 are described herein in connection with FIGS. 5 through 7.

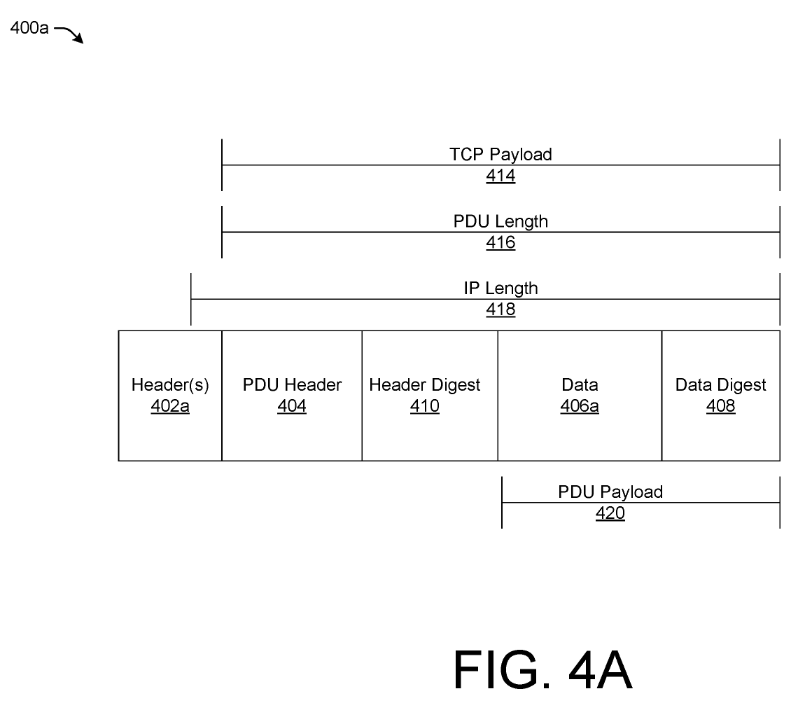

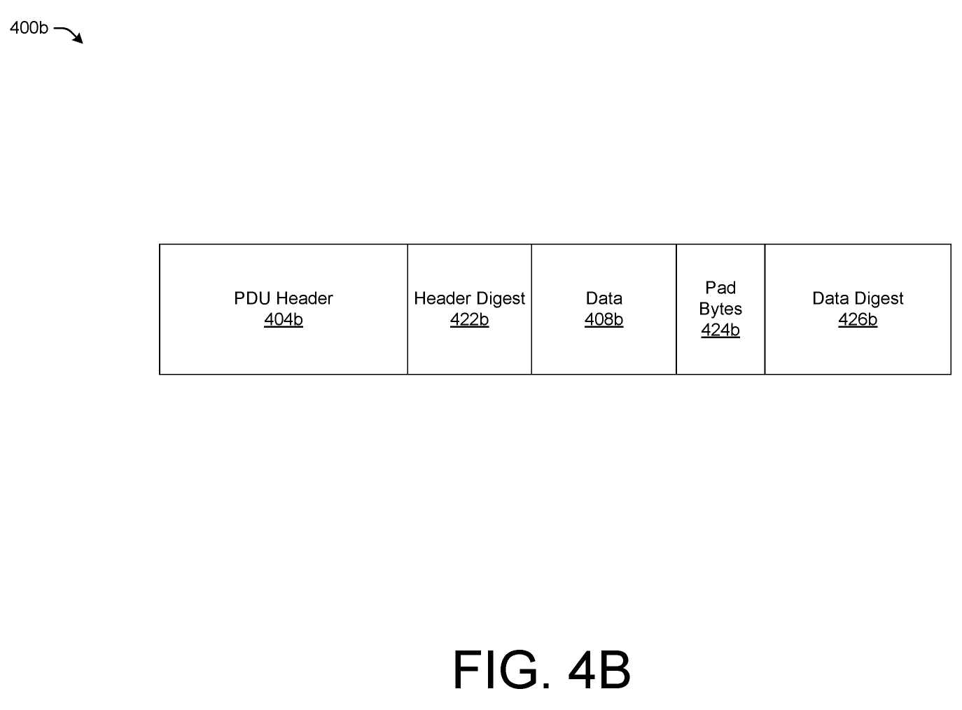

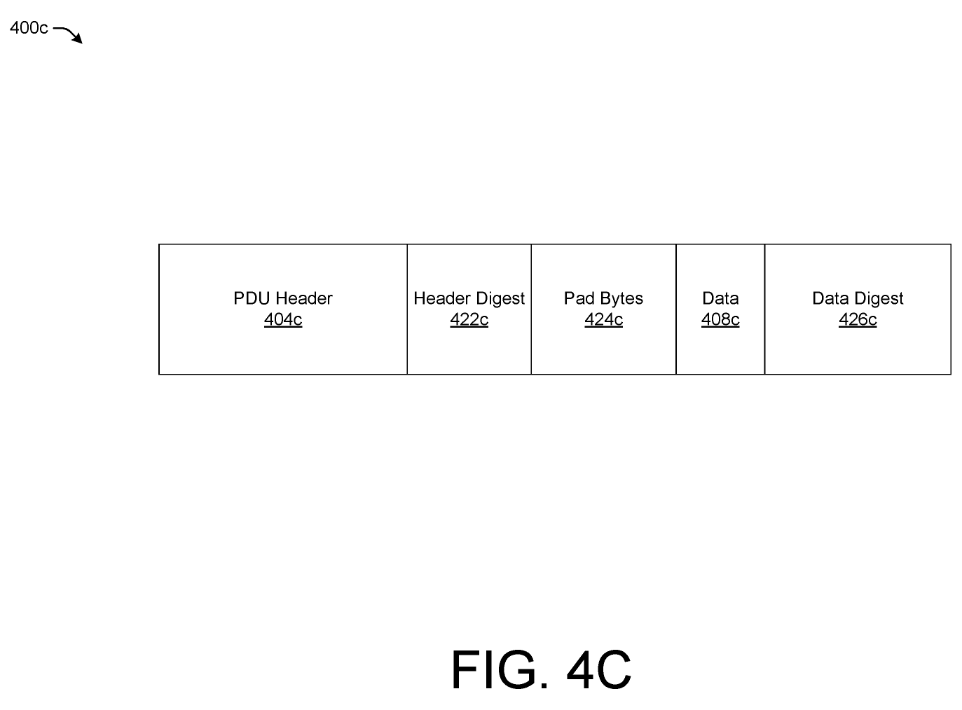

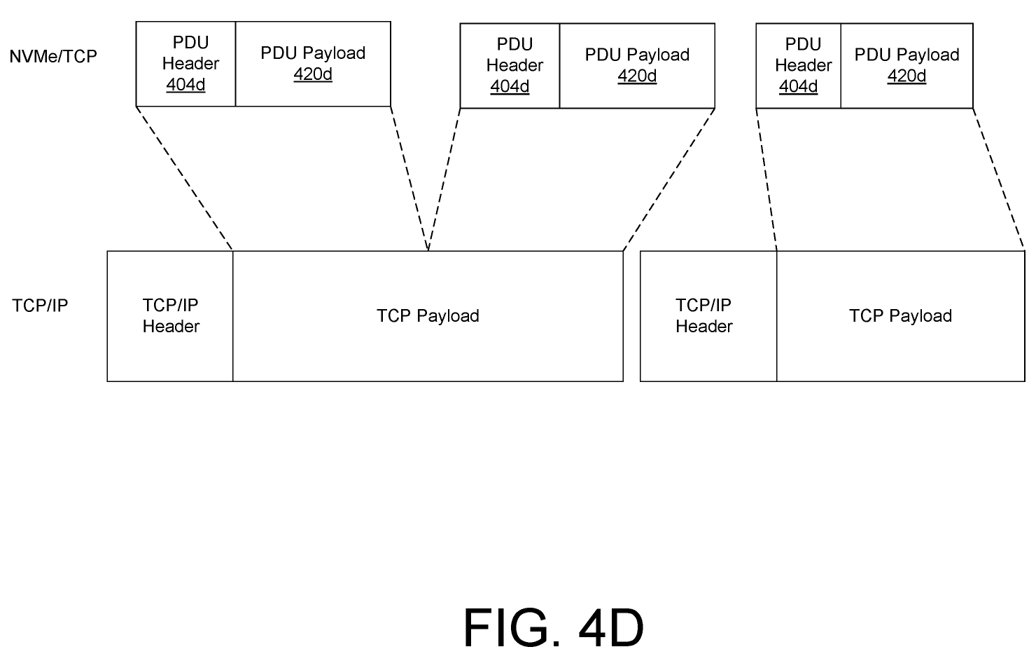

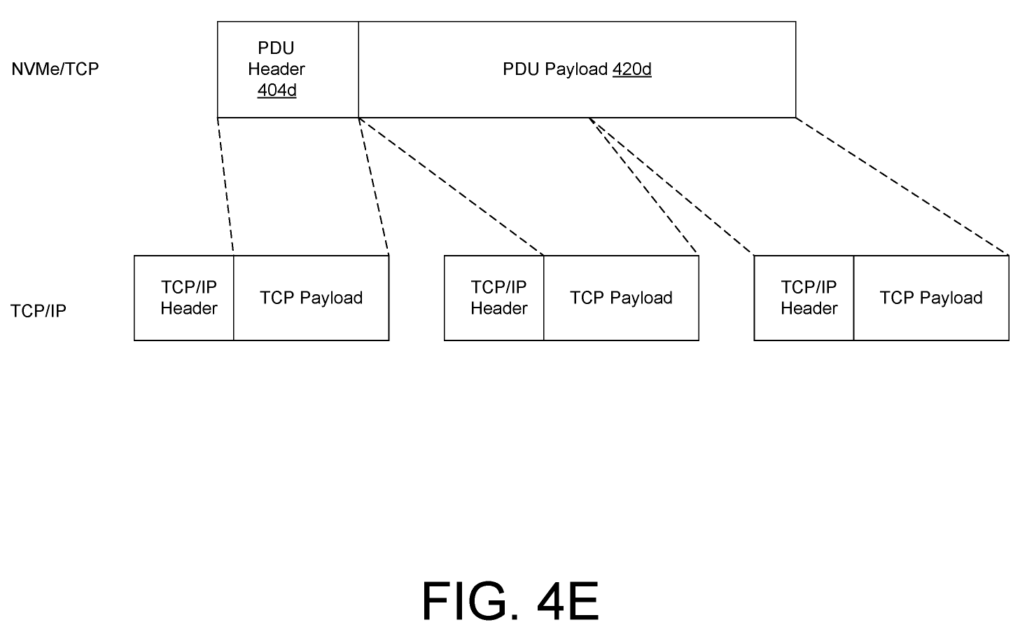

FIG. 4A illustrates a diagram of a data packet 400a including a header(s) 402, a header digest, data digest, and TCP, IP, and Ethernet headers, according to an example of the principles described herein. By way of example, the data packet 400a may include any data packet sent or received by the network adapter 126 and may include a transmission control protocol/Internet protocol (TCP/IP) frame that includes header(s) 402, a TCP payload 414 that has a length equivalent to a PDU length 416. Further, the data packet 400a may include an IP length 418. The TCP payload 414 may include one or more complete or partial PDU(s) that are aligned with the start of the TCP payload 414. A PDU header 404 may include the header digest 410 information for each of the PDU(s) associated with a data TX 138 and data RX 140 processes. Further, the PDU header 404 may include the data associated with performing iSCSI or NVMe/TCP PDU delineation and TCP/IP transmission of the data.

Further, the PDU header 404 may be included as part of the PDU payload 420 along with data 406 for transmission. The data packet 400a may include the data digest information for each of the PDU(s) associated with a data TX 138 and data RX 140 processes within, for example, the PDU payload.

FIG. 4B illustrates a diagram of a data packet in the form of an iSCSI PDU 400b including a PDU header 404b, a header digest 422b, data 408b, pad bytes 424b, and a data digest 426b. iSCSI initiator and iSCSI target communicate over TCP/IP by exchanging iSCSI PDUs 400b. An iSCSI PDU 400b may be used to transfer a SCSI command, data, or control/status information. As shown in FIG. 4B, an iSCSI PDU 400b consists of five parts. The PDU header 404b is required in all PDUs. The PDU header digest (HDGST) 422b, the PDU data 408b, the PDU pad bytes 424b and the data digest field 426b are included or omitted based on the PDU type and the values exchanged during connection establishment. The length of the iSCSI PDU 400b is PDU dependent, and digests (header 422b and data 426b) are included only after being enabled during connection establishment. PAD bytes 424b are included if DataSegmentLength is not a multiple of 4. In configurations, the PDU header 404b consists of a Basic Header Segment (BHS) that has a fixed length of 48 bytes and an Additional Header Segment (AHS), which has a variable length.

FIG. 4C illustrates a diagram of a data packet in the form of a NVMe/TCP PDU 400c including a PDU header 404c, a header digest 422c, pad bytes 424c, data 408c, and a data digest 426c. A host and a controller in an NVM subsystem communicate over TCP/IP by exchanging NVMe/TCP PDUs 400c. An NVMe/TCP PDU 400c may be used to transfer a NVMe command, data, or control/status information. As shown in FIG. 4C, an NVMe/TCP PDU consists of five parts. The PDU header 404c is required in all PDUs. The PDU header digest (HDGST) 422c, the PDU data 408c, the PDU pad bytes 424c and the data digest field 426c are included or omitted based on the PDU type and the values exchanged during connection establishment. The length of the NVMe/TCP PDU 400c is PDU dependent, and digests (header 422c and data 426c) are included only after being enabled during connection establishment. PAD bytes 424c are included only after being communicated during connection establishment. In configurations, the PDU header 404c consists of a PDU common header that has a fixed length of 8 bytes and a PDU specific header, which has a variable length. As shown in FIGS. 4D and 4E, there is no requirement to align NVMe/TCP PDU headers 404d nor PDU payloads 420d to TCP/IP packet boundaries.

FIG. 5 illustrates a packet transfer diagram 500 including an input/output (I/O) request PDU 502 that is transmitted with a DDP TAG, according to an example of the principles described herein. As previously noted, a Direct Data Placement (DDP) hardware offload driver, e.g., hardware offload driver 108, at a data-receiving computing device 538 may allocate a DDP TAG. This DDP TAG defines a region within a memory. A hardware offload driver may write data buffer DMA addresses and lengths in the memory region defined by the DDP TAG and may fill the DDP TAG and data transfer length in Read command PDU header, or fill DDP TAG, buffer offset and data transfer length in the R2T PDU header and send Read command or R2T PDU to data-transmitting computing device via PDU transmit work request.

A data-transmitting computing device 540 on receiving a Read command or R2T PDU may fill the DDP TAG, buffer offset and data length in the header of data PDU and send data PDU(s) to data-receiving computing device.

The network adapter 126 at the data-receiving computing device receives a data PDU. The DDP module of the network adapter may utilize the DDP TAG in the data PDU header as an index to fetch data buffer DMA addresses and lengths from the memory and DMA writes the data into the data buffers.

As an example, FIG. 5 presents an overview how an I/O request and a data packet 400 (e.g., data packets 400a, 400b, and 400c) may be transmitted with a DDP TAG. A number of data packets 400 may be transferred between a data transmitting computing device 540 and a data receiving computing device 538. In doing so, an I/O request PDU 502 may be transmitted from the data receiving computing device 538 to the data transmitting computing device 540 at 530. The I/O request PDU 502 may include a DDP TAG, buffer offset and data transfer length 504. Once received, the data transmitting computing device 540 may then transmit, at 532, a first data PDU (e.g., data PDU 1 506). The data PDU 1 506 may include a PDU header 508, data 510, and DDP TAG, buffer offset and data length 512, among other elements.

At 534, the data transmitting computing device 540 may then transmit a second or subsequent data PDU (e.g., data PDU 2 514). The data PDU 2 514 may include a PDU header 516, data 518, and DDP TAG, buffer offset and data length 520, among other elements. Similarly, at 536, the data transmitting computing device 540 may then transmit a third or subsequent data PDU (e.g., data PDU N 522). The data PDU N 522 may include a PDU header 524, data 526, and an DDP TAG, buffer offset and data length 528, among other elements. Any number of data PDUs may be transmitted by the data transmitting computing device 540 as indicated by the ellipsis depicted at the bottom of FIG. 5.

With the above description of the DDP TAG within the DDP computing environment 100, the computing device 300 including the network adapter 126 and the DDP module 330, and the data packet 400 including the DDP TAG, buffer offset, and data length, example methods of how the DDP TAG may be used for directly placing the data into the iSCSI or NVMe/TCP stack data buffers will now be described. According to an example of the principles described herein. The method may include with a data-receiving computing device that includes the capabilities of the computing device 300 of FIG. 3, allocating a DDP TAG for an I/O request packet to be sent to a data-transmitting computing device that includes the capabilities of the computing device 300 of FIG. 3. In one example, hardware offload driver on the data-receiving computing device may allocate DDP TAG for the I/O request packet being transmitted.

The allocation of the DDP TAG may include the association of the DDP TAG with a region within a memory such as network adapter memory or computing device memory. The region may be divided in configurable size units where each unit has an index. This index serves as the DDP TAG. Hardware offload driver at data-receiving computing device may write the data buffer DMA addresses and lengths in this region as the information or data defining the buffer where network adapter has to write the data.

Hardware offload driver at data-receiving computing device may insert DDP TAG, buffer offset and data transfer length into the header of an I/O request PDU 502 and send this PDU to data-transmitting computing device.

Data-transmitting computing device receives I/O request PDU, the network adapter or the application at data-transmitting computing device may insert the DDP TAG, buffer offset and data length into a header such as the PDU header 404 of the TCP payload 414 of the data packet 400. In one example, the DDP TAG may be placed anywhere within the data packet 400 as may be beneficial for obtaining the data buffer DMA addresses and lengths. In this manner, the DDP TAG may be included within the data packet 400 in order to utilize the DDP TAG for directly placing the data into the data buffers. Data-transmitting computing device sends data PDU to data-receiving computing device.

Network adapter 126 at the data-receiving computing device receives data PDU, network adapter may read DDP TAG from the data PDU header and DDP module 330 of network adapter 126 may utilize DDP TAG as an index to fetch data buffer DMA addresses and lengths from the network adapter memory or computing device memory.

DDP module 330 of the network adapter 126 at the data-receiving computing device may directly place (e.g., via DMA write process) the data into the data buffers.

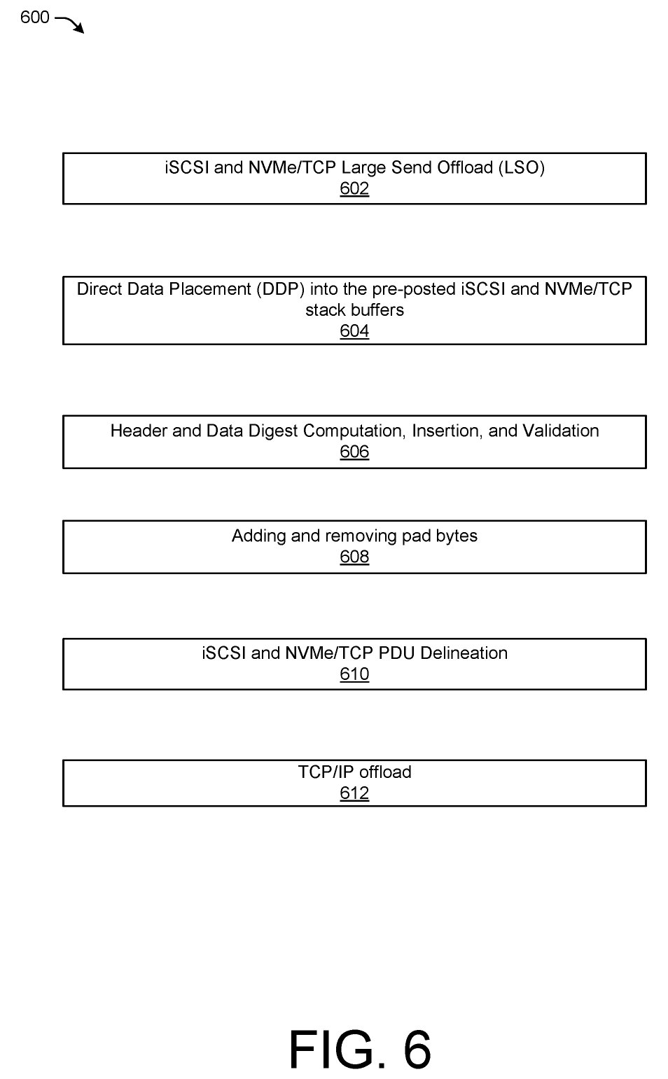

FIGS. 6-11 illustrate flow diagrams of example methods 600-1100 and that illustrate aspects of the functions performed at least partly by the computing device 100, 300 as described in FIGS. 1 through 5. The logical operations described herein with respect to FIGS. 6-11 may be implemented (1) as a sequence of computer-implemented acts or program modules running on a computing system and/or (2) as interconnected machine logic circuits or circuit modules within the computing system. In one example, the method(s) 600-1100 may be performed by a system comprising one or more processors and one or more non-transitory computer-readable media storing computer-executable instructions that, when executed by the one or more processors, cause the one or more processors to perform the method(s) 600-1100.

The implementation of the various components described herein is a matter of choice dependent on the performance and other requirements of the computing device 100, 300. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 6-11 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 6 illustrates multiple hardware offload features of the network adapter, according to an example of the principles described herein. The method 600 may include, at 602, performing an iSCSI or NVMe/TCP large send offload (LSO). The LSO may include any data processing technique for increasing egress throughput of high-bandwidth network connections by reducing overhead at the CPU(s) 304.

An LSO may include passing a multipacket buffer to the network adapter 126. The network adapter 126 may then split this buffer into separate packets. Thus, when a system needs to send large chunks of data out over a computer network, the chunks of data may first need breaking down into smaller segments that can pass through all the network elements like routers and switches between the source and destination computers. This process is referred to as segmentation. In one example, the TCP protocol in the computing device 100, 300 performs this segmentation. Offloading this work to the network adapter 126 as contemplated herein may be referred to as TCP segmentation offload (TSO).

For example, a unit of 64 KiB (65,536 bytes) of data may be segmented to 45 segments of 1460 bytes each by the network adapter 126 and transmitted over the network. With some intelligence in the network adapter 126, the CPU(s) 304 may hand over the 64 KB of data to the network adapter 126 in a single transmit-request, the network adapter 126 may break that data down into smaller segments of, for example, 1460 bytes, add the TCP, IP, and data link layer protocol headers according to a template provided by the TCP/IP stack of the computing device 100, 300 to each segment, and send the resulting frames over the network. This significantly reduces the work done by the CPU(s) 304.

In case of iSCSI and NVMe/TCP segmentation offload network adapter may receive a PDU transmit work request including header and data buffer DMA addresses, lengths and maximum PDU size, network adapter may DMA read the header and data buffer into the network adapter memory and form multiple smaller PDUs based on maximum PDU size in the PDU transmit work request, may add pad bytes and header and data digest in each PDU, may transmit PDU via TCP/IP stack in the network adapter, may send PDU transmit completion message to hardware offload driver, e.g., hardware offload driver 108.

At 604, the network adapter 126 may perform direct data placement (DDP) of solicited PDU data into the pre-posted iSCSI or NVMe/TCP stack buffers. DDP protocol provides information to place incoming data directly into a receive buffer of an upper layer protocol without intermediate buffers. This removes excess CPU and memory bandwidth utilization associated with transferring data through the intermediate buffers. DDP enables an upper layer protocol (ULP) to send data to a data sink without requiring the data sink to place the data in an intermediate buffer. Thus, when the data arrives at, for example, the computing device 100, 300 acting as the data sink, the network adapter 126 may place the data directly into the buffer of the ULP. This may enable the computing device 100, 300 to consume substantially less memory bandwidth than a buffered model because the computing device 100, 300 is not required to move the data from the intermediate buffer to the final destination. Additionally, this may enable the network protocol to consume substantially fewer CPU cycles than if the CPU 304 was used to move the data, and this can remove the bandwidth limitation of only being able to move data as fast as the CPU 304 can copy the data. DDP preserves ULP record boundaries (messages) while providing a variety of data transfer mechanisms and completion mechanisms to be used to transfer ULP messages.

At 606, the network adapter 126 may perform the header and data digest computation, insertion, and validation. The network adapter may also add and remove pad bytes at 608.

At 610, the network adapter 126 may perform iSCSI and NVMe/TCP PDU delineation. Delineation of the iSCSI and NVMe/TCP PDUs may include identifying first and last byte of the PDU in the TCP payload.

At 612, the network adapter 126 may break the PDU down into smaller segments, add the TCP, IP, and data link layer protocol headers according to a template provided by the hardware offload driver to each segment and transmit the resulting frames over the network.

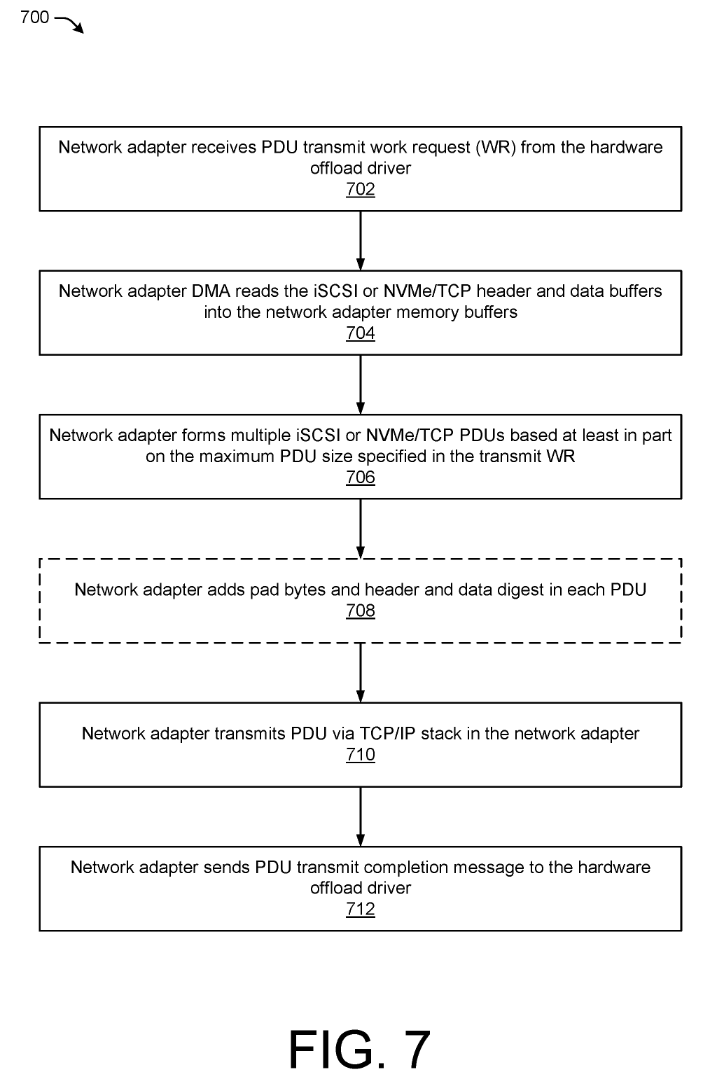

FIG. 7 illustrates a flow diagram of an example method 700 for hardware offload utilizing PDU transmit work request (WR) processing (e.g., the data transmit (TX) 138 described above) by the network adapter 126, according to an example of the principles described herein. The network adapter 126, at 702, may receive a transmit WR from the driver, e.g., the hardware offload driver 108, associated with the OS 102. The transmit WR may include header and data buffer DMA addresses, lengths and maximum PDU size. At 704, the network adapter may DMA read the iSCSI or NVMe/TCP header and iSCSI or NVMe/TCP data buffers into memory buffers of the network adapter 126. The network adapter 126 may form multiple iSCSI or NVMe/TCP PDUs based at least in part on the maximum PDU size specified in the transmit WR at 606.

Optionally, at 708, the network adapter 126 may add pad bytes and header and data digest data into the PDUs. At 710, the network adapter 126 may transmit PDUs via TCP/IP stack in the network adapter to another computing device via a network to which the computing device 100, 300 is coupled. At 712, the network adapter may send PDU transmit completion message to the hardware offload driver.

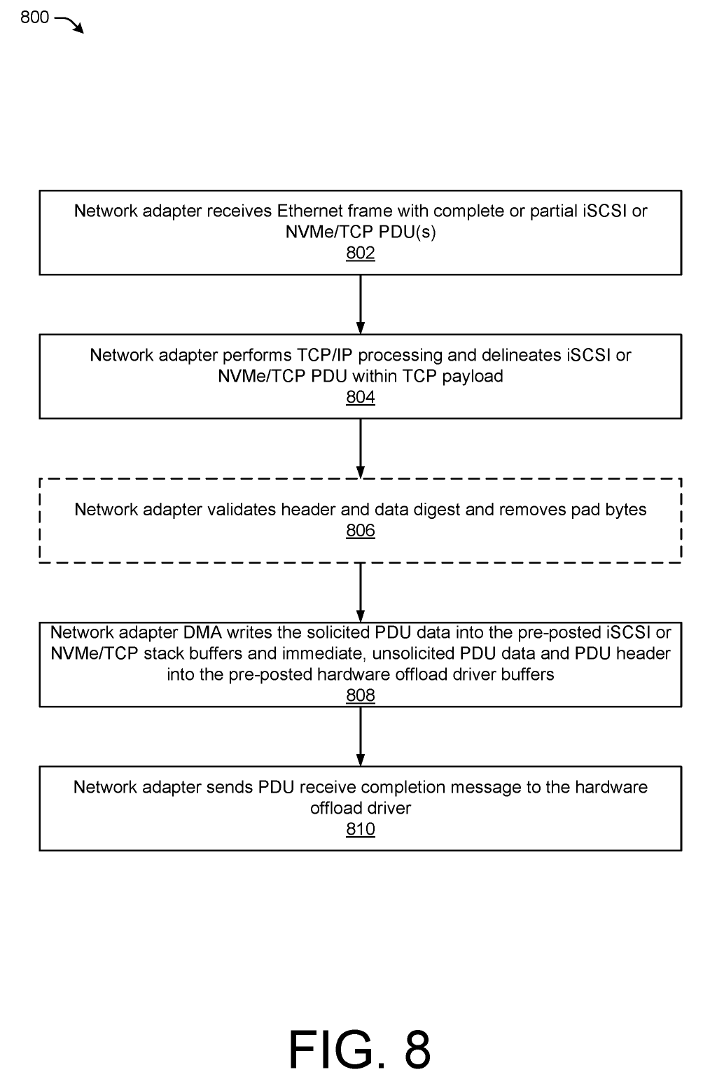

FIG. 8 illustrates a flow diagram of an example method 800 for hardware offload utilizing Ethernet frame receive (RX) processing (e.g., the data receive (RX) 140 processes described above) by the network adapter 126, according to an example of the principles described herein. The method 800 may include, at 802, receiving the Ethernet frame with complete or partial iSCSI or NVMe/TCP PDU(s) at the network adapter 126. The network adapter 126 may perform TCP/IP processing and delineate iSCSI or NVMe/TCP PDUs within TCP payload at 804.

Optionally at 806, the network adapter 126 may validate the header and data digest and remove pad bytes. At 808, the network adapter 126 may DMA write solicited PDU data into the pre-posted iSCSI or NVMe/TCP stack buffers and immediate, unsolicited PDU data and PDU headers into the pre-posted hardware offload driver buffers. Data and header from the PDUs may then be stored in the computing device memory buffers (e.g., RAM 308), network adapter and/or the storage device (e.g., NVMe SSD) 318 memory buffers, and/or be processed by the CPU(s) 304. At 810, the network adapter may send PDU receive completion message to the hardware offload driver.

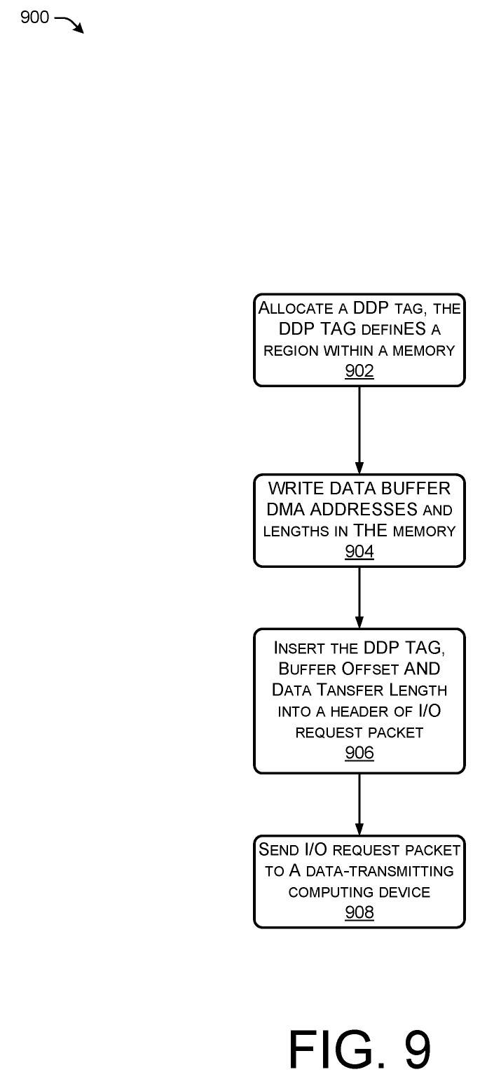

FIG. 9 illustrates a flow diagram of an example method 900 of DDP, according to an example of the principles described herein.

At 902, the hardware offload driver may allocate a DDP TAG. The DDP TAG defines a region within a memory such as, for example, the network adapter memory or computing device memory. At 904, the hardware offload driver may write the data buffer DMA addresses and lengths in the memory region defined by DDP TAG. The DDP TAG, buffer offset and data transfer length may be inserted into the header of I/O request packet (e.g., the I/O request PDU 502) at 906. At 908, the I/O request packet (e.g., the I/O request PDU 502) may be sent to the data-transmitting computing device 540.

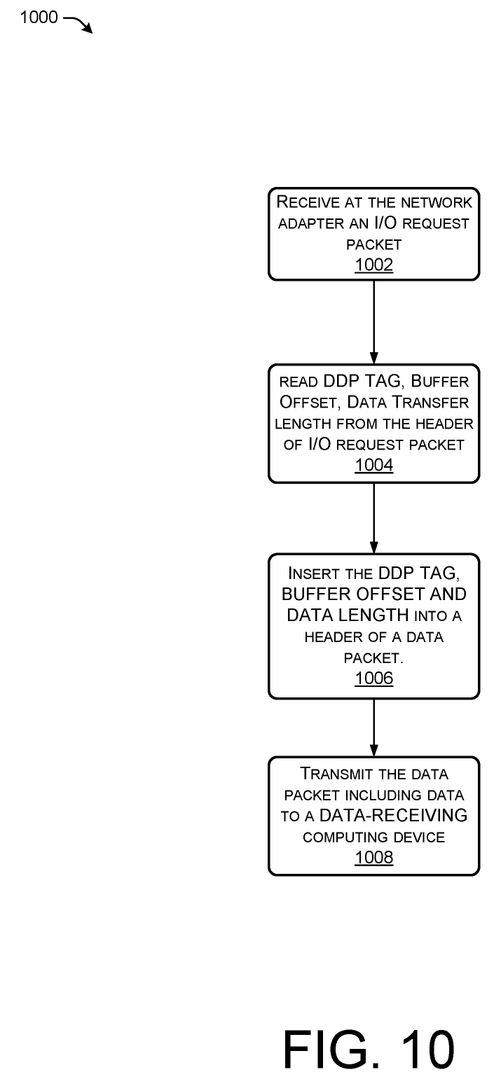

FIG. 10 illustrates a flow diagram of an example method 1000 of DDP, according to an example of the principles described herein. The method 1000 of FIG. 10 may include, at 1002, receiving, at the network adapter 126 of the data-transmitting computing device 540, an I/O request packet (e.g., the I/O request PDU 502). The I/O request packet (e.g., the I/O request PDU 502) may be read including the DDP TAG, the buffer offset, and the data transfer length from the header of I/O request packet (e.g., the I/O request PDU 502).

At 1006 and with a data-transmitting computing device that includes the capabilities of the computing device 100, an DDP TAG, buffer offset and data length may be inserted in a data packet 400 (e.g., data packets 400a, 400b, 400c) to be sent to a data-receiving computing device (e.g., the data-receiving computing device 538) that includes the capabilities of the computing device 100 as similarly described above. Further, as similarly described above, the network adapter 126 or the application may insert the DDP TAG, buffer offset and data length into a header such as the PDU header 404 of the TCP payload 414 of the data packet 400.

At 1008, the data packet 400 may be transmitted to the data-receiving computing device (e.g., data-receiving computing device 538) with the data packet 400 including the data 406 and the DDP TAG, buffer offset and data length.

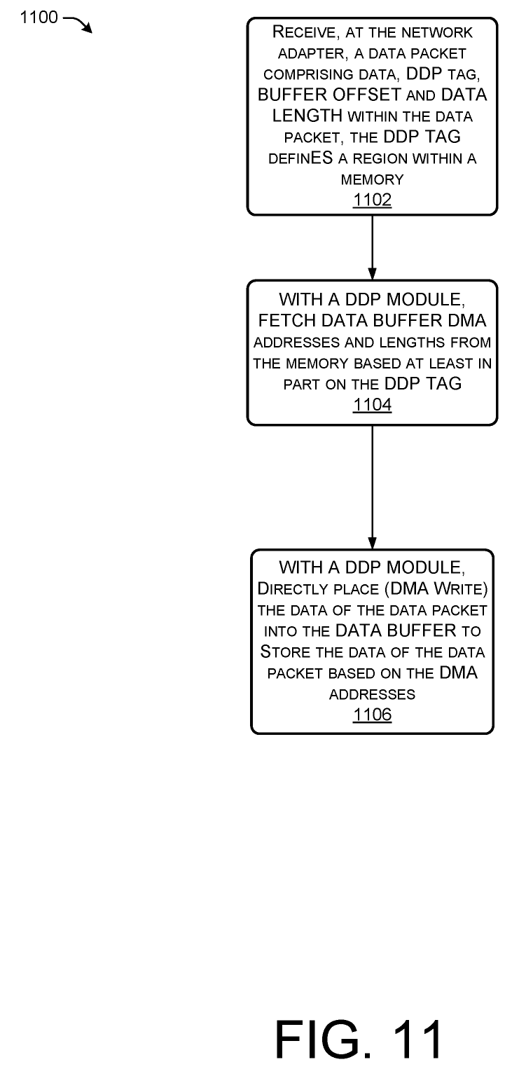

FIG. 11 illustrates a flow diagram of an example method 1100 of DDP, according to an example of the principles described herein. The method 1100 of FIG. 11 may include processing performed by a data-receiving computing device as described herein. At 1102, the method 1100 may include receiving, at the network adapter 126, the data packet comprising data, a DDP TAG, buffer offset, and data length within a header of the data packet 400 (e.g., data packets 400a, 400b, 400c), the DDP TAG defining a region within a memory such as the network adapter memory or computing device memory.

At 1104, the method may include, with the DDP module 330 fetching data buffer DMA addresses and lengths from the memory based at least in part on the DDP TAG received with the data packet 400 at 1104.

Further, at 1106, the network adapter 126 with the DDP module 330 may directly place (e.g., via a DMA write process) the data of the data packet 400 into the data buffers to store the PDU data based on the DMA addresses.

Thus, with the use of the DDP, the network adapter 126 executing the DDP module 330 may receive data directly in iSCSI or NVMe/TCP stack data buffers. This significantly decreases CPU and memory bandwidth utilization and I/O latency.

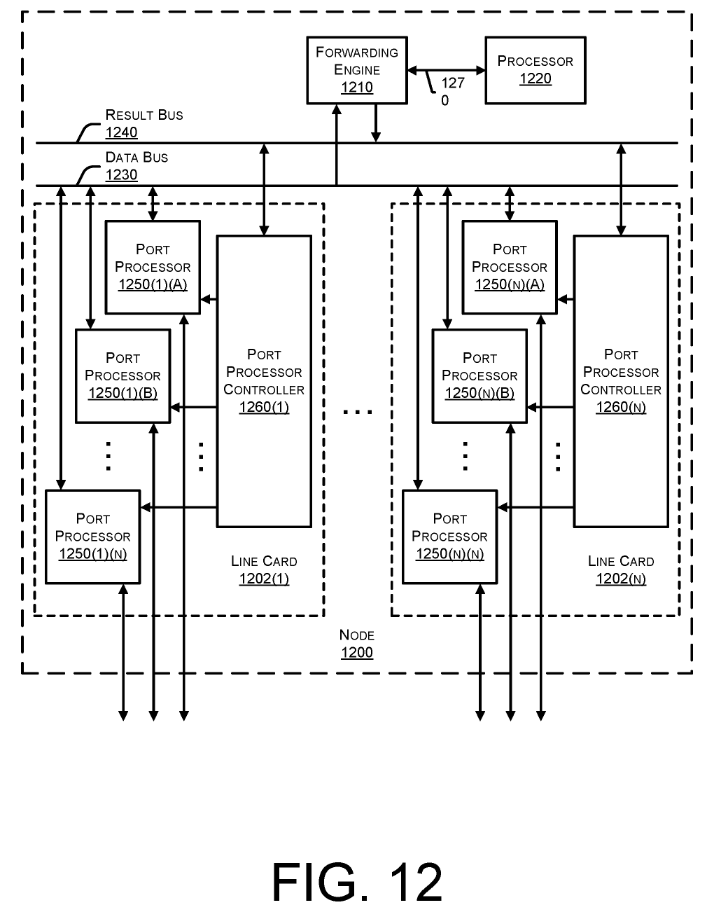

FIG. 12 illustrates a block diagram illustrating certain components of an example node 1200 that can be utilized to implement various aspects of the technologies disclosed herein. In one example, node(s) 1200 may be employed in various networks, such as, for example, a network to which the computing device 100, 300 as described with respect to FIGS. 1 through 11.

In one example, the node 1200 may include any number of line cards 1202 (e.g., line cards 1202(1)-(n), where n may be any integer greater than 1) that are communicatively coupled to a forwarding engine 1210 (also referred to as a packet forwarder) and/or a processor 1220 via a data bus 1230 and/or a result bus 1240. The line cards 1202(1)-(n) may include any number of port processors 1250(1)(A)-(n)(n) which are controlled by port processor controllers 1260(1)-(n), where n may be any integer greater than 1. Additionally, or alternatively, a forwarding engine 1210 and/or processor 1220 are not only coupled to one another via the data bus 1230 and the result bus 1240 but may also communicatively coupled to one another by a communications link 1270.

The processors (e.g., the port processor(s) 1250 and/or the port processor controller(s) 1260) of each line card 1202 may be mounted on a single printed circuit board. When a packet or packet and header are received, the packet or packet and header may be identified and analyzed by node 1200 (also referred to herein as a computing device 100, 300 including the network adapter 126) in the following manner. Upon receipt, a packet (or some or all of its control information) or packet and header may be sent from one of the port processor(s) 1250(1)(A)-(n)(n) at which the packet or packet and header was received and to one or more of those devices coupled to the data bus 1230 (e.g., others of the port processor(s) 1250(1)(A)-(n)(n), the forwarding engine 1210 and/or the processor 1220). Handling of the packet or packet and header may be determined, for example, by the forwarding engine 1210. For example, the forwarding engine 1210 may determine that the packet or packet and header should be forwarded to one or more of port processors 1250(1)(A)-(n)(n). This may be accomplished by indicating to corresponding one(s) of port processor controllers 1260(1)-(n) that the copy of the packet or packet and header held in the given one(s) of the port processor(s) 1250(1)(A)-(n)(n) should be forwarded to the appropriate one of port processor(s) 1250(1)(A)-(n)(n). Additionally, or alternatively, once a packet or packet and header has been identified for processing, the forwarding engine 1210, the processor 1220, and/or the like may be used to process the packet or packet and header in some manner and/or may add packet security information in order to secure the packet. On a node 1200 sourcing such a packet or packet and header, this processing may include, for example, encryption of some or all of the information in the packet or packet and header, the addition of a digital signature, and/or some other information and/or processing capable of securing the packet or packet and header. On a node 1200 receiving such a processed packet or packet and header, the corresponding process may be performed to recover or validate the information in the packet or packet and header that has been secured.

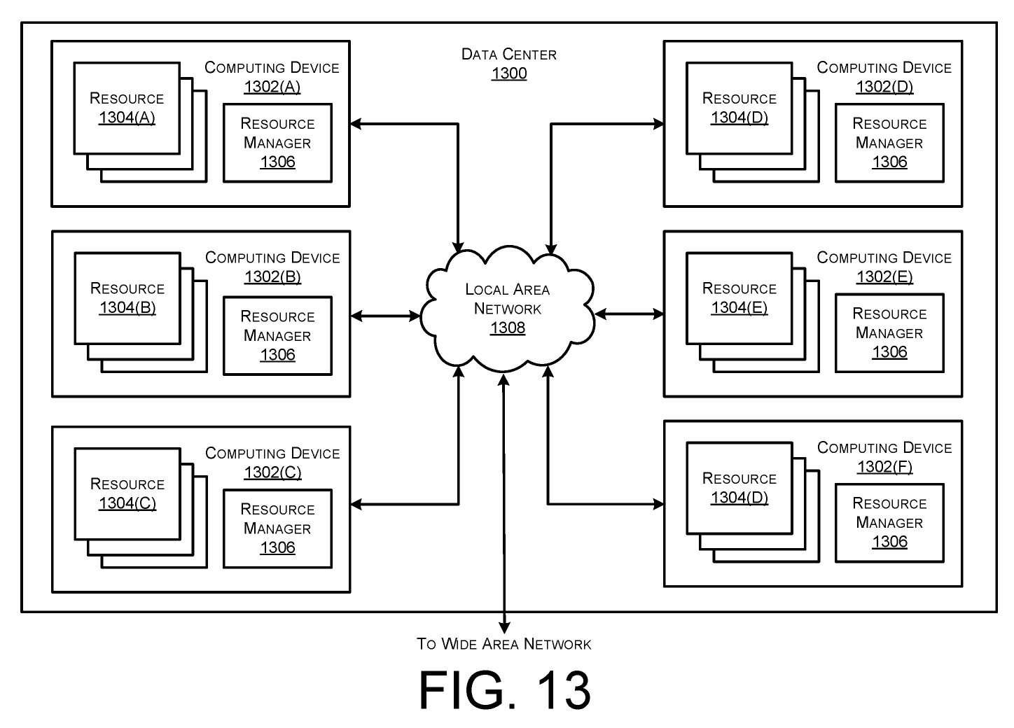

FIG. 13 illustrates a computing system diagram illustrating a configuration for a data center 1300 that may be utilized to implement aspects of the technologies disclosed herein. The example data center 1300 shown in FIG. 13 includes several computing devices 1302A-1302F (which might be referred to herein singularly as “a computing device 1302” or in the plural as “the computing devices 1302”) for providing computing resources. In one example, the computing devices 1302 may include server computers, the computing devices 100, 300 of FIGS. 1-3, or other computing devices described herein. In one example, the resources and/or computing devices 1302 may include, or correspond to, any type of networked device described herein. Further, although described as servers, the computing devices 1302 may comprise any type of networked device, such as servers, switches, routers, hubs, bridges, gateways, modems, repeaters, access points, etc.

The computing devices 1302 may be standard tower, rack-mount, or blade server computers configured appropriately for providing computing resources. In one example, the computing devices 1302 may provide computing resources 1304 including data processing resources such as VM instances or hardware computing systems, database clusters, computing clusters, storage clusters, data storage resources, database resources, networking resources, virtual private networks (VPNs), and others. Some of the computing devices 1302 may also be configured to execute a resource manager 1306 capable of instantiating and/or managing the computing resources. In the case of VM instances, for example, the resource manager 1306 may be a hypervisor or another type of program configured to enable the execution of multiple VM instances on a single computing device 1302. Computing devices 1302 in the data center 1300 may also be configured to provide network services and other types of services.

In the example data center 1300 shown in FIG. 13, an appropriate LAN 1308 is also utilized to interconnect the computing devices 1302A-1302F and may include the LAN 324 described herein. It may be appreciated that the configuration and network topology described herein has been greatly simplified and that many more computing systems, software components, networks, and networking devices may be utilized to interconnect the various computing systems disclosed herein and to provide the functionality described above. Appropriate load balancing devices or other types of network infrastructure components may also be utilized for balancing a load between data centers 1300, between each of the computing devices 1302A-1302F in each data center 1300, and, potentially, between computing resources in each of the computing devices 1302. It may be appreciated that the configuration of the data center 1300 described with reference to FIG. 13 is merely illustrative and that other implementations may be utilized. In one example, the computing devices 1302 and or the computing resources 1304 may each execute/host one or more tenant containers and/or virtual machines to perform techniques described herein.

In some instances, the data center 1300 may provide computing resources, like tenant containers, VM instances, VPN instances, and storage, on a permanent or an as-needed basis. Among other types of functionalities, the computing resources provided by a cloud computing network may be utilized to implement the various services and techniques described herein. The computing resources 1304 provided by the cloud computing network may include various types of computing resources, such as data processing resources like tenant containers and VM instances, data storage resources, networking resources, data communication resources, network services, VPN instances, and the like.

Each type of computing resource 1304 provided by the cloud computing network may be general-purpose or may be available in a number of specific configurations. For example, data processing resources may be available as physical computers or VM instances in a number of different configurations. The VM instances may be configured to execute applications, including web servers, application servers, media servers, database servers, some or all of the network services described above, and/or other types of programs. Data storage resources may include file storage devices, block storage devices, and the like. The cloud computing network may also be configured to provide other types of computing resources 1304 not mentioned specifically herein.

The computing resources 1304 provided by a cloud computing network may be enabled in one example by one or more data centers 1300 (which might be referred to herein singularly as “a data center 1300” or in the plural as “the data centers 1300). The data centers 1300 are facilities utilized to house and operate computer systems and associated components. The data centers 1300 typically include redundant and backup power, communications, cooling, and security systems. The data centers 1300 may also be located in geographically disparate locations. One illustrative example for a data center 1300 that may be utilized to implement the technologies disclosed herein is described herein with regard to, for example, FIGS. 1 through 12.

While the systems and methods presented herein are described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

The examples described herein provide a computing device may include a hardware offload driver, and a network adapter communicatively coupled to the hardware offload driver. The network adapter may include iSCSI and NVMe/TCP transmit and receive offload module, Direct Data Placement (DDP) module, and TCP/IP module. The network adapter performs operations including, during a transmit offload process, receiving from the hardware offload driver, PDU transmit work request for offloading PDU transmit operation to the network adapter, and generating a plurality of iSCSI or NVMe/TCP protocol data units (PDUs) from the PDU transmit work request based at least in part on a maximum PDU size. The network adapter may add pad bytes and header and data digest in each PDU and transmits PDU via TCP/IP stack in the network adapter and sends PDU transmit completion to the hardware offload driver. Further, during a receive offload process, the network adapter may perform TCP/IP processing, delineates iSCSI or NVMe/TCP PDU within TCP payload. On receiving complete PDU the network adapter may validate header and data digest, may remove pad bytes and may place the solicited PDU data into the pre-posted iSCSI or NVMe/TCP stack buffers and immediate, unsolicited PDU data and the PDU header into the pre-posted hardware offload driver buffers and send PDU receive completion message to the hardware offload driver.

With the above-described systems and methods, significant computing resources may be freed up by the processing performed by the network adapter rather than the CPU or other processing device. The present systems and methods remove processing overhead from the CPU and associated OS to the network adapter and associated processing and memory resources. Migration of these processes to the network adapter allows for the host computing device to focus on other processing tasks. Further, in one example, a portion of the processing load may be pushed to the hardware of the network adapter, and a portion of the processing load may remain with and be processed by the CPU. By offloading these processing tasks to the network adapter, the computing device may experience a significant reduction in CPU and memory bandwidth utilization and I/O latency.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A computing device, comprising:
a hardware offload driver; and
a network adapter communicatively coupled to the hardware offload driver, the network adapter comprising an internet small computer systems interface (iSCSI) and non-volatile memory (NVM) Express (NVMe)/transmission control protocol (TCP) transmit and receive offload module, a Direct Data Placement (DDP) module, a TCP/Internet protocol (IP) module, wherein the network adapter is configured to, during a transmit offload process, perform operations comprising:
during a transmit offload process:
receiving from the hardware offload driver, a PDU transmit work request for offloading PDU transmit operation to the network adapter; and
generating a plurality of iSCSI or NVMe/TCP protocol data units (PDUs) from the data in the PDU transmit work request based at least in part on a maximum PDU size; and
during a receive offload process, at least one of TCP/IP processing or delineating iSCSI or NVMe/TCP PDUs within a TCP payload.

2. The computing device of claim 1, further comprising:
an iSCSI stack; and
an NVMe/TCP stack,
wherein the iSCSI stack and the NVMe/TCP stacks are communicatively coupled to the hardware offload driver.

3. The computing device of claim 1, wherein the PDU transmit work request comprises header buffer and data buffer direct memory access (DMA) addresses, lengths, and maximum PDU size.

4. The computing device of claim 1, wherein the transmit offload process further comprises:
adding pad bytes; and
adding a header digest and a data digest to the PDUs.

5. The computing device of claim 4, wherein the receive offload process further comprises:
based at least in part on receiving a complete iSCSI or NVMe/TCP PDU, validating the header digest and the data digest within the PDU; and
removing pad bytes.

6. The computing device of claim 1, wherein the transmit offload process further comprises:
transmitting PDUs via the TCP/IP module in the network adapter.

7. The computing device of claim 1, wherein the transmit offload process further comprises:
sending a PDU transmit completion message to the hardware offload driver.

8. The computing device of claim 1, wherein the receive offload process further comprises:
placing solicited PDU data into pre-posted iSCSI or NVMe/TCP stack buffers and immediate, unsolicited PDU data and PDU header into pre-posted hardware offload driver buffers.

9. The computing device of claim 8, wherein the iSCSI or NVMe/TCP stack buffers and hardware offload driver buffers include computing device, network adapter and storage device memory buffers.

10. The computing device of claim 1, wherein the receive offload process further comprises:
sending a PDU receive completion message to the hardware offload driver.

11. The computing device of claim 1, wherein the receive offload process further comprises:
zero copy receive for immediate, unsolicited PDU data and PDU headers by passing PDU data and header buffer addresses to an iSCSI or NVMe/TCP stack.

12. A non-transitory computer-readable medium storing instructions that, when executed, causes a processor to perform operations, comprising:
during a transmit offload process at a network adapter:
receiving, from a hardware offload driver of an operating system, a PDU transmit work request for offloading PDU transmit operation to the network adapter;
generating a plurality of internet small computer systems interface (iSCSI) and non-volatile memory (NVM) Express (NVMe)/transmission control protocol (TCP) protocol data units (PDUs) from the data in the PDU transmit work request based at least in part on a maximum PDU size; and
during a receive offload process at the network adapter, at least one of TCP/Internet protocol (IP) processing or delineating iSCSI or NVMe/TCP PDUs within a TCP payload.

13. The non-transitory computer-readable medium of claim 12, wherein the PDU transmit work request comprises header buffer and data buffer direct memory access (DMA) addresses, lengths, and maximum PDU size.

14. The non-transitory computer-readable medium of claim 12, wherein the transmit offload process further comprises:
adding pad bytes; and
adding a header digest and a data digest to the PDUs.

15. The non-transitory computer-readable medium of claim 14, wherein the receive offload process further comprises:
based at least in part on receiving a complete iSCSI or NVMe/TCP PDU, validating the header digest and the data digest within the PDU; and
removing pad bytes.

16. The non-transitory computer-readable medium of claim 12, wherein the transmit offload process further comprises:
transmitting PDUs via a TCP/IP module in the network adapter.

17. The non-transitory computer-readable medium of claim 12, wherein the transmit offload process further comprises:
sending a PDU transmit completion message to the hardware offload driver.

18. The non-transitory computer-readable medium of claim 12, wherein the receive offload process further comprises:
placing solicited PDU data into pre-posted iSCSI or NVMe/TCP stack buffers and immediate, unsolicited PDU data and PDU header into pre-posted hardware offload driver buffers.

19. The non-transitory computer-readable medium of claim 18, wherein the iSCSI or NVMe/TCP stack buffers and hardware offload driver buffer includes computing device, network adapter and storage device memory buffers.

20. The non-transitory computer-readable medium of claim 12, wherein the receive offload process further comprises:
sending a PDU receive completion message to the hardware offload driver.

21. The non-transitory computer-readable medium of claim 12, wherein the receive offload further comprises:
zero copy receive for immediate, unsolicited PDU data and PDU headers by passing PDU data and header buffer addresses to an iSCSI or NVMe/TCP stack.

22. A method for hardware offload, comprising, with an internet small computer systems interface (iSCSI) and non-volatile memory (NVM) Express (NVMe)/transmission control protocol (TCP) transmit and receive offload module, Direct Data Placement (DDP) module and TCP/(Internet protocol (IP) module of a network adapter:
performing a transmit offload process comprising:
receiving, from a hardware offload driver of an operating system, a PDU transmit work request for offloading PDU transmit operation to the network adapter; and
generating a plurality of iSCSI or NVMe/TCP protocol data units (PDUs) from header buffer and data buffer direct memory access (DMA) addresses, lengths and a maximum PDU size in the PDU transmit work request based at least in part on the maximum PDU size; and
performing a receive offload process comprising TCP/IP processing; delineating iSCSI or NVMe/TCP PDUs within TCP payload.

23. The method of claim 22, wherein the transmit offload process further comprises:
adding pad bytes; and
adding a header digest and a data digest to the PDUs.

24. The method of claim 23, wherein the receive offload process further comprises:
based at least in part on receiving a complete iSCSI or NVMe/TCP PDU, validating the header digest and the data digest within the PDU; and
removing pad bytes.

25. The method of claim 22, wherein the transmit offload process further comprises:
transmitting PDUs via the TCP/IP module in the network adapter.

26. The method of claim 22, wherein the transmit offload process further comprises:
sending a PDU transmit completion message to the hardware offload driver.

27. The method of claim 22, wherein the receive offload process further comprises:
placing solicited PDU data into pre-posted iSCSI or NVMe/TCP stack buffers and immediate, unsolicited PDU data and PDU header into pre-posted hardware offload driver buffers.

28. The method of claim 27, wherein the iSCSI or NVMe/TCP stack buffers and hardware offload driver buffer include computing device, network adapter and storage device memory buffers.

29. The method of claim 22, wherein the receive offload process further comprises:
sending a PDU receive completion message to the hardware offload driver.

30. The method of claim 22, wherein the receive offload process further comprises:
zero copy receive for immediate, unsolicited PDU data and PDU header by passing PDU data and header buffer addresses to an iSCSI or NVMe/TCP stack.
